(19) United States
(12) Patent Application Publication
(10) Pub. No.: US 2018/0017123 A1
(43) Pub. Date: Jan. 18, 2018

(54) BRAKE LINING FOR A PARTIAL-LINING DISK BRAKE, ARRANGEMENT OF A BRAKE LINING ON A LINING HOLDER, AND METHOD FOR ACTUATING A BRAKE LINING HELD ON A LINING HOLDER

(71) Applicant: KNORR-BREMSE SYSTEME FÜR SCHIENENFAHRZEUGE GMBH, München (DE)

(72) Inventors: Marc-Gregory ELSTORPFF, München (DE); Michael MATHIEU, Puchheim (DE); Alexander JUNG, Gauting (DE); Erich FUDERER, Fürstenfeldbruck (DE); Marco LANGWADT, München (DE)

(21) Appl. No.: 15/538,508

(22) PCT Filed: Dec. 17, 2015
(86) PCT No.: PCT/EP2015/080125

§ 371 Date: Jun. 21, 2017

(30) Foreign Application Priority Data
Dec. 23, 2014 (DE) 102014119491.8

(51) Int. Cl. F16D 69/04; B61H 5/00; F16D 65/092; F16D 69/00

(52) U.S. Cl. CPC F16D 69/0408; F16D 65/092; B61H 5/00; F16D 2069/0433; F16D 2069/004

(57) ABSTRACT

A brake lining for a partial-lining disk brake of a rail vehicle includes a lining carrier and a plurality of lining elements mounted on the lining carrier via carrier plates spherically, wherein the mounting of the lining elements on the lining carrier via the carrier plates are designed such that a surface pressure of the lining elements generated by a brake application force during pressing of the lining elements against a brake disk decreases radially relative to the axis of rotation of the brake disk with increasing distance of the lining elements from the axis of rotation of the brake disk.

### CROSS REFERENCE AND PRIORITY CLAIM

This patent application is a U.S. National Phase of International Patent Application No. PCT/EP2015/080125, filed 17 Dec. 2015, which claims priority to German Patent Application No. 102014119491.8, filed 23 Dec. 2014, the disclosures of which are incorporated herein by reference in their entirety.

### FIELD

Disclosed embodiments relate to a brake lining for a partially lined disk brake of a rail vehicle. More specifically, disclosed embodiments pertain to an arrangement of a brake lining of this type on a lining holder of a brake disk arrangement of a rail vehicle, and to a method for actuating a brake lining which is secured on a lining holder of a brake disk arrangement of a rail vehicle.

### BACKGROUND

A brake lining of the generic type is described in EP 07 847 61. In the case of the brake lining which is described therein, a very uniform input of heat into the brake disk of the disk brake is achieved by way of a division of the overall lining area into a plurality of small lining elements and by way of a statically determined transmission of a brake application force of a caliper lever of a disk brake of a rail vehicle to the lining elements. The force of the caliper lever is distributed uniformly to respective halves of a lining carrier, on which the lining elements are secured, by a lining holder, on which the brake lining is secured. That force of the caliper lever which acts on a half of this type of the lining carrier is supported via in each case three carrier plates which are mounted on the lining carrier. The force is distributed in such a way that all the carrier plates are loaded uniformly. Each of the carrier plates in turn distributes the force which is exerted by the caliper lever, once again in a uniform manner, to the lining elements which are mounted on a carrier plate of this type.

An arrangement of this type of a carrier plate with lining elements which are held thereon via spherical bearings will be called a group element in the following text.

The group elements and also the three lining elements of a group element of this type lie on different orbital path diameters in relation to the brake disk, against which the lining elements bear in the case of a braking operation.

As a result of the positioning of the lining elements on different orbital path cross sections, the sliding velocity of the lining elements on the brake disk is also of different magnitude.

Owing to the different sliding velocities, in the case of an identical surface pressure of the lining elements, wear of the lining elements at a different speed and therefore an oblique position of the carrier plate and even of the entire lining holder can occur. The mounting of the lining elements on the carrier plate is designed in such a way that they lie on the brake disk with a surface pressure which is constant over the surface area. Since, however, the local sliding velocity is not constant over the element surface area, each of the lining elements is also prone to oblique wear. If the oblique wear is too great within a lining element or else within a group element, this can lead to single-sided contact of the lining elements on the carrier plate or the carrier plates on the lining carrier. As a result, the desired uniform distribution of force is impaired, as a result of which the contact pattern of the brake lining deteriorates.

Thus, the performance of a disk brake is limited, inter alia, by the surface temperature which occurs on the friction face of the brake disk. In this way, hot cracks which grow at an excessive surface temperature occur, which hot cracks can reach impermissible sizes and make a replacement of the brake disk necessary as a result.

The greater the fluctuations in the surface temperature on the brake disk, the lower the thermal energy which a brake disk can absorb without damage during a braking operation. Accordingly, a brake lining of optimum design introduces the thermal energy into the brake disk uniformly over the entire friction face, without producing relatively great temperature differences (for example, hotspots) on the surface.

In order to comply with the abovementioned requirements, the brake linings of rail vehicles, in particular of high speed trains, are of very complicated construction, with the result that they, as a wear part, cause a considerable proportion of the operating costs of rail vehicles of this type. The wear of a brake lining is, inter alia, substantially dependent on the surface pressure between the brake lining and the brake disk and on the sliding velocity of the brake disk on the friction linings.

v′˜P^{α}·v^{β},

where
v′ is the wear speed
P is the surface characteristic values
v is the sliding velocity, and
α, β are material characteristic values

[Saumweber, Gerum: “Grundlagen der Schienenfahrzeugbremse” [Foundations of the rail vehicle brake], Hestra-Verlag]

For the abovementioned reasons, oblique wear of the brake linings often occurs during operation of rail vehicles of this type. Therefore, the brake linings often have to be replaced, without it being possible to completely utilize the existing wear volume of the brake linings.

### SUMMARY

Disclosed embodiments provide a brake lining for rail vehicles, an arrangement of a brake lining of this type on a lining holder of a brake disk arrangement of a rail vehicle, and a method for actuating a brake lining which is secured on a lining holder of a brake disk arrangement of a rail vehicle, by way of which wear is achieved which proceeds as uniformly as possible over the entire lining surface area, in order to utilize the existing wear volume in an optimum manner, to prevent premature replacement of the brake lining on account of obliquely wearing elements or element groups, and to obtain a uniform input of heat from the lining elements into the brake disk independently of the wear state of the lining elements, by way of a uniform contact pattern being maintained.

This is achieved by way of a brake lining for a rail vehicle, an arrangement of a brake lining of this type on a lining holder of a brake disk arrangement of a rail vehicle, and a method for actuating a brake lining which is secured on a lining holder of a brake disk arrangement of a rail vehicle in accordance with the disclosed embodiments.

### BRIEF DESCRIPTION OF FIGURES

In the following text, exemplary embodiments of disclosed embodiments will be described in greater detail using the appended drawings, in which:

FIGS. 1 and 2 show perspective views of one design variant of a brake lining according to disclosed embodiments, which is fixed on a lining holder,

FIG. 3 shows a perspective view of one optional design variant of a group element of a brake lining,

FIGS. 4 and 5 show plan views of different design variants of a brake lining according to disclosed embodiments with group elements of different configuration with lining elements of different size (FIG. 4) and lining elements of identical size (FIG. 5),

FIG. 6 shows a sectional view of a brake lining radially with respect to the rotational axis of a brake disk (in the installed state of the brake lining) in order to illustrate the brake application force which decreases radially to the outside,

FIG. 7 shows a sectional view through a lining element of the brake lining in the radial direction, in order to illustrate the brake application force which decreases radially to the outside, and

FIG. 8 shows a perspective view of a lining holder of a brake disk arrangement of a rail vehicle.

### DETAILED DESCRIPTION

In the case of the brake lining according to disclosed embodiments, the mounting of the lining elements on the lining carrier via the carrier plates may be designed such that a surface pressure of the lining elements which is produced by way of a brake application force during pressing of the lining elements onto a brake disk decreases radially with respect to the rotational axis of the brake disk at an increasing spacing of the lining elements from the rotational axis of the brake disk.

In the case of lining elements which are subjected to a relatively high sliding velocity, the lower surface pressure which is brought about in this way results in an equalization of the two factors which contribute to the wear speed, which leads to an approximately identical wear speed of all the lining elements of the brake lining.

In this way, moreover, a uniform contact pattern of the brake lining is maintained. Finally, an optimized utilization of the wear volume of the brake lining is also achieved.

In accordance with one advantageous design variant of the brake lining according to disclosed embodiments, the bearing elements of the lining elements which transmit the brake application force to the lining elements during a braking operation are arranged on the lining elements such that they are offset with respect to the centroid of the lining elements radially toward the rotational axis of the brake disk.

As a result, a surface pressure is set among the individual lining elements, which surface pressure decreases from the edge which lies radially on the inside to the edge which lies radially on the outside, in accordance with the wear law.

In accordance with a further advantageous design variant of disclosed embodiments, a plurality of group elements which are formed from in each case one carrier plate and a plurality of lining elements which are mounted on it are arranged on the lining carrier.

Here, each of the group elements optionally has three lining elements.

In accordance with a further advantageous design variant of disclosed embodiments, the carrier plates are designed in such a way that the bearing elements for spherical mounting have a lining carrier and cutouts which are spaced apart from the respective bearing element and in which the bearing elements of the lining elements are received.

In order to adapt the mean surface pressure of the elements of a group element in accordance with the orbital path diameter, on which they are positioned, the carrier plates are shaped, in accordance with one advantageous design variant of disclosed embodiments, in such a way that the brake force which is transmitted from the carrier plates to the bearing elements which are coupled to them is identical for each of the lining elements of a carrier plate, the friction face of the lining elements of lining elements which are arranged radially further to the outside being larger than the friction face of the lining elements of lining elements which are arranged radially further to the inside.

Since the surface pressure is inversely proportional to the friction face of the lining elements, the larger friction face of lining elements which are arranged radially further to the outside results in a lower surface pressure, in the case of an identical loaded brake force, than in the case of the lining elements which are arranged closer radially to the rotational axis of the brake disk and have a smaller friction face.

According to one alternative design variant, the carrier plates are shaped in such a way that the brake force which is transmitted from the carrier plates to the bearing elements which are coupled to them is lower for lining elements of a carrier plate which are arranged radially further to the outside than for lining elements of a carrier plate which are arranged radially further to the inside, the friction face of all the lining elements being of identical size.

The different distribution of the brake force which is transmitted to a group element of this type is optionally achieved by virtue of the fact that, in the case of a carrier plate for a group element with a lining element which lies radially on the outside, the length ratio of the radial spacings between the bearing point of a lining element which is arranged radially further to the outside and the bearing point of the group element and between the bearing point of a lining element which is arranged radially further to the inside and the bearing point of the group element is greater than 2.

In the case of a carrier plate for a group element with a lining element which lies radially on the inside, the length ratio of the radial spacings between the bearing point of a lining element which is arranged radially further to the inside and the bearing point of the group element and between the bearing point of a lining element which is arranged radially further to the outside and the bearing point of the group element is lower than 2.

According to one optional design variant, the carrier plates themselves are provided with fingers which extend away from the bearing element and in which the cutouts for receiving the bearing elements of the lining elements are provided.

In accordance with one optional design variant, the arrangement of the individual lining elements is brought about in such a way that in each case two of the lining elements of a group element are received in a respective cutout of the carrier plate, which cutout lies approximately on a circle line which is concentric with respect to the rotational axis of the brake disk.

Here, the arrangement according to disclosed embodiments of a brake lining of the partially lined disk brake of a rail vehicle on a lining holder of a brake disk arrangement of the rail vehicle is distinguished by a brake lining which is configured as above.

In the following description of the figures, terms such as top, bottom, left, right, front, rear, etc. relate exclusively to the exemplary illustration and position selected in the respective figures of the brake lining, the lining elements, the carrier plates, the lining carrier, the lining holder and other parts. The terms are not to be understood to be restrictive, that is to say the references can change as a result of different operating positions or the mirror-symmetrical design or the like.

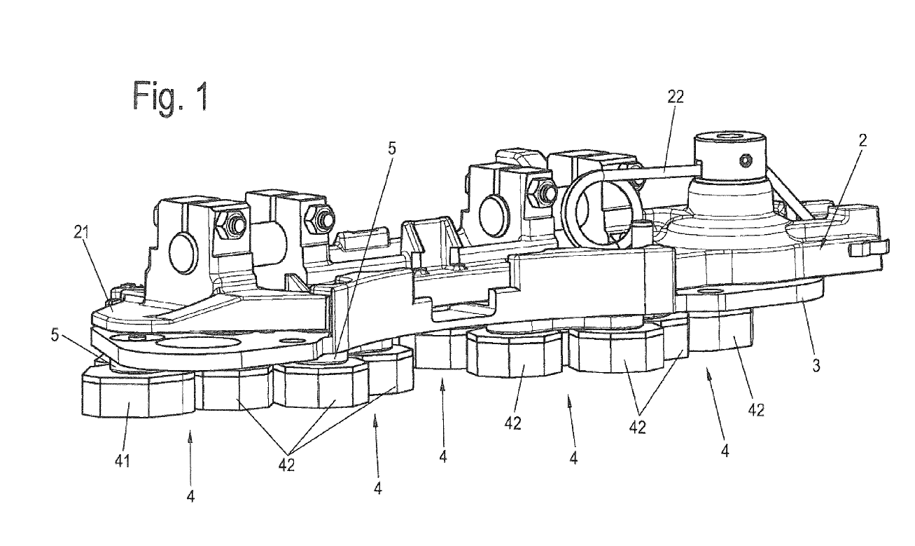

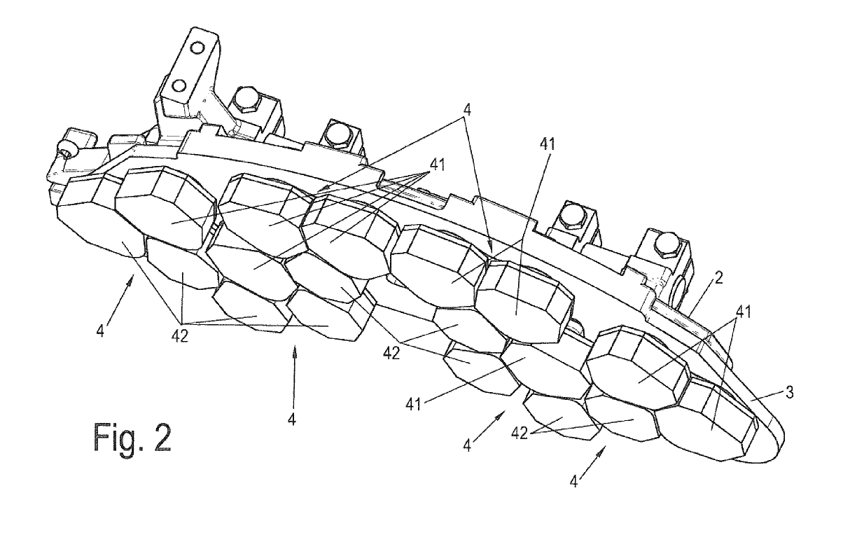

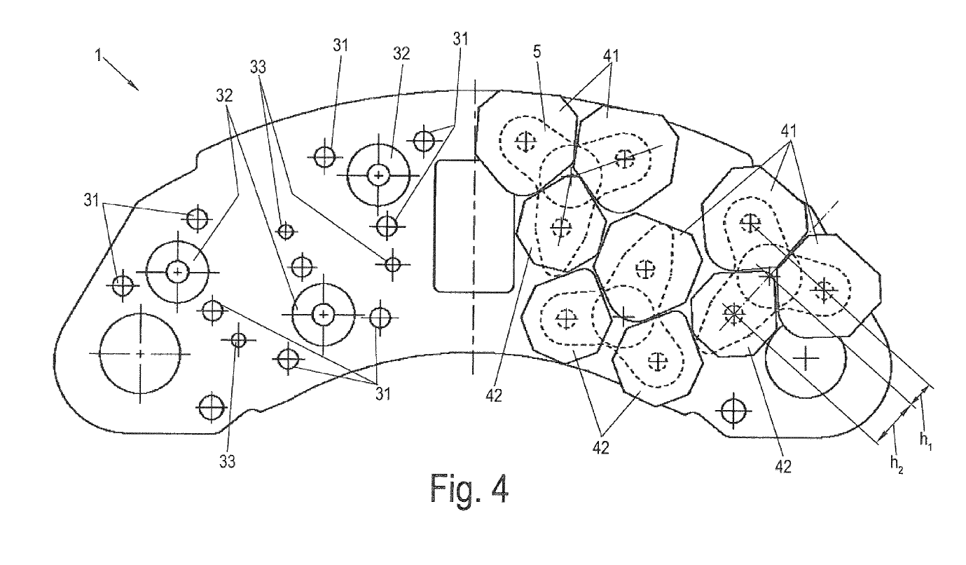

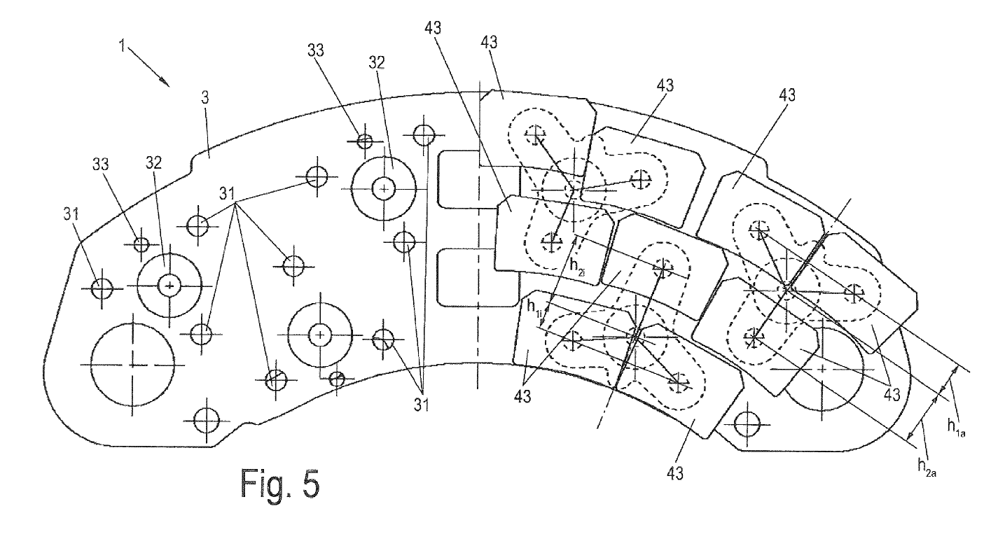

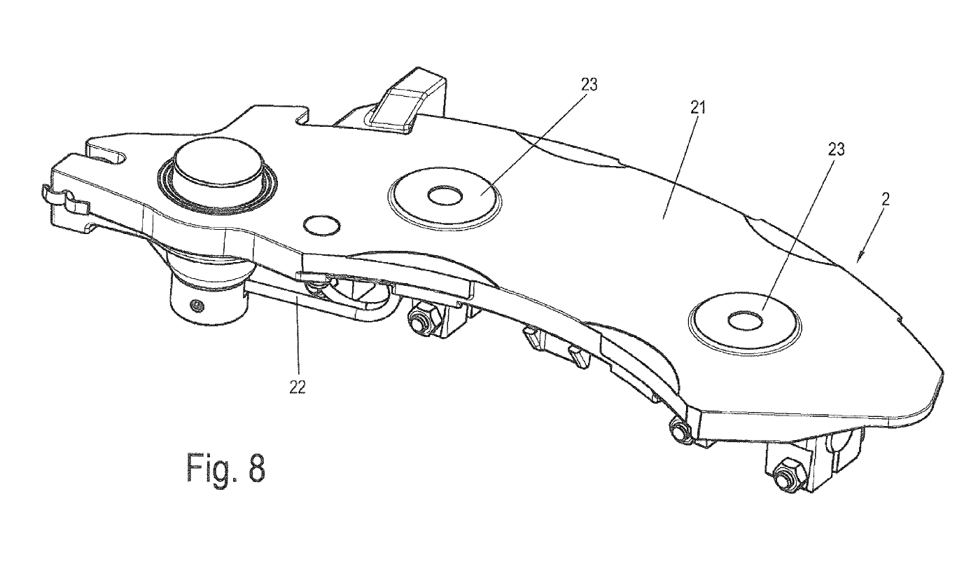

In FIGS. 4 and 5, two design variants of a brake lining according to disclosed embodiments are denoted overall by the designation 1. Here, a brake lining 1 of this type of a partially lined disk brake of a rail vehicle is fixed on a lining holder 2 during use, as shown in FIGS. 1 and 2 (with a brake lining 1 which is fixed on the lining holder 2) and FIG. 8 (without a brake lining).

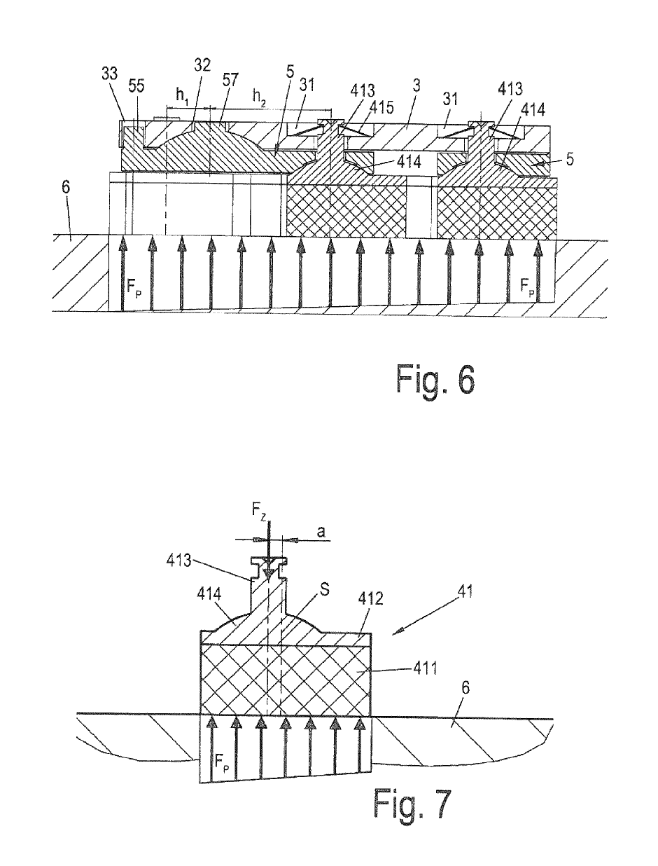

As can be seen in FIGS. 1, 2 and 5, a brake lining of this type for a partially lined disk brake of a rail vehicle has a lining carrier 3 which can be fixed on the lining holder 2, and a plurality of lining elements 41, 42, 43 which are mounted on the lining carrier 3 via carrier plates 5. Here, the lining elements 41, 42, 43 are mounted spherically on the carrier plates 5. The carrier plates 5 themselves are mounted spherically on the lining carrier 3, as shown in FIG. 6.

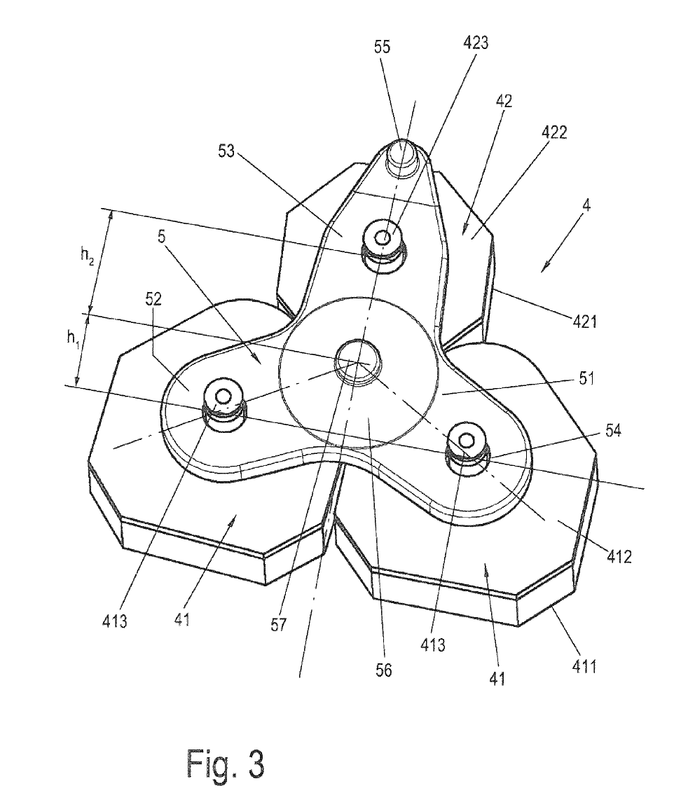

In each case three of the lining elements 41, 42, 43 are optionally arranged on a carrier plate 5, as shown by way of example in FIG. 3.

Here, the mounting of the lining elements 41, 42, 43 via the carrier plates 5 on the lining carrier 3 takes place in such a way that a surface pressure P of the lining elements 41, 42, 43 which is produced brake application force F_{Z} during pressing of the lining elements 41, 42, 43 on a brake disk 6 decreases radially with respect to the rotational axis of the brake disk 6 at an increasing spacing of the lining elements 41, 42, 43 from the rotational axis of the brake disk 6, as shown by way of example in FIG. 6.

FIG. 6 shows arrows which are denoted by F_{P} and represent the pressing force on the lining elements 41, 42, 43 which acts on the brake disk 6. As shown in this sectional view through one design variant of the brake lining 1 according to disclosed embodiments (section radially with respect to the rotational axis of the brake disk 6), the pressing force which acts on the lining elements 41, 42, 43 decreases at an increasing radial spacing from the rotational axis of the brake disk 6.

In order to achieve a distribution of this type of the surface pressure, as shown by way of example in FIGS. 6 and 7, spherical faces 414 which are integrally formed on the element carrier plates 412 of the lining elements 41, which element carrier plates 412 carry friction linings 411, and transmit the brake application force F_{Z} to the lining elements 41, which brake application force F_{Z} is exerted on the brake lining during a braking operation, are arranged in such a way that the brake application force F_{Z} does not act on the centroid S of the lining element 41, but rather are arranged offset by a distance a with respect to the centroid of the lining elements 41 radially toward the rotational axis of the brake disk 6. Here, the spherical faces 414 are optionally configured as spherical cap-shaped elevations. The further lining elements 42, 43 which are shown in FIGS. 4 and 5 are likewise with spherical faces 414 of this type.

The distribution (shown diagrammatically in FIG. 7) of the pressing force F_{P} of the brake disk 6 to the lining elements 41, 42, 43 arises as a result of the offset.

Here, the bearing elements 56 of the carrier plates 5 for spherical mounting of the carrier plates 5 on the lining carrier 3 are optionally configured as spherical caps with cams 57 which arise centrally from the lining carrier 3, the respective bearing elements 56 lying in correspondingly shaped spherical recesses 32 on that side of the lining carrier 3 which faces away from the lining holder 2.

Here, as can be seen clearly in FIG. 3, the carrier plates 5 themselves are optionally configured with fingers 51, 52, 53 which extend from the bearing element 56 and in which the cutouts 54 for receiving the bearing elements 413, 423 of the lining elements 41, 43 are provided.

Other shapes of the carrier plates are also conceivable, however. It is important to design the carrier plates 5 in such a way that a tilting movement with respect to the lining holder 3 is made possible.

Here, the cutouts 54 are spherically shaped on their sides which face away from the carrier plate 3 and on the sides which face the lining elements 41, 42, 43, as shown in FIG. 6. A through hole is provided centrally in the spherical part of the recess, through which through hole the bearing elements 413, 423 of the lining elements 41, 42, 43 extend into recesses 31 in the lining carrier 3 which are provided to this end, and are secured resiliently in the recesses 31 by way of spring elements 415, for example in the form of disk springs or shaped springs.

The mounting of the carrier plates 5 on the lining carrier 3 accordingly takes place in such a way that, as shown in FIG. 6, the brake application force acts on the spherical part of the bearing element 56 of the carrier plate 5.

Here, the transmission of the brake application force from the lining holder 2 to the lining carrier 3 optionally takes place via pressing faces 23 (shown in FIG. 8) which project out of the rear side of the lining holder 2, which rear side faces the lining carrier 3.

A cam 57 rises up centrally out of the spherical part of the bearing element 56 of the carrier plate 5, which cam 57 prevents the spherical part (configured as a ball face here) of the bearing element 56 from sliding out of the spherical cap of the lining carrier 3 by way of an additional positively locking connection, if an unexpectedly high frictional force or another, high and correspondingly directed force (for example, as a result of damage to the brake disk) occurs.

Here, the cutouts 54 for receiving the bearing elements 413, 423 of the lining elements 41, 42, 43 are arranged relative to the cam 57 in such a way that the spacing h₁ from the cutouts 54 of two of the lining elements 41 is lower than the spacing h₂ from the cutout 54 of a bearing element 41 of a third lining element 42. Accordingly, the distribution of force to the three lining elements 41, 42 of a group element 4 is defined via the lengths h₁ and h₂.

As can be seen clearly in FIGS. 4 and 5, in each case two lining elements 41, 42, 43 of a group element 4 are optionally arranged in a respective approximately on a circle line which is concentric with respect to the rotational axis of the brake disk 6.

In addition to the spherical mounting of the carrier plates 5 via the spherically shaped bearing element 56, a further cam 55 is optionally integrally formed at one end of one of the fingers 51, 52, 53 on that side of the carrier plate 5 which is assigned to the lining carrier 3, which cam 55 extends into a correspondingly shaped recess 33 of the carrier plate 3.

Here, as can be seen in FIG. 6, the cam 55 is slightly flatter than the cam 57 of the bearing element 56, which makes a seesaw movement of the carrier plate 5 with respect to the lining carrier 3 during operation possible. The seesaw movement of the carrier plate 5 with respect to the lining carrier 3 and of the lining elements 41, 42, 43 with respect to the carrier plate 5 is limited by way of the play between the respective two parts.

As shown, in particular, in FIG. 4, the carrier plates 5 are shaped in one optional design variant of the brake lining according to disclosed embodiments in such a way that the brake force which is transmitted from the carrier plates 5 to the bearing elements 56 which are coupled to them is identical for each of the lining elements 41, 42 of a carrier plate 5, the friction face of the lining elements 41, 42 of lining elements 41 which are arranged radially further to the outside being larger than the friction face of the lining elements 41, 42 of lining elements 42 which are arranged radially further to the inside.

In order to achieve a uniform wear speed of all the lining elements 41, 42, the surface area ratio A₁/A₂ of the lining elements 41, 42 of different size on one carrier plate 5 is determined by means of the orbital path diameter D₁, D₂, on which respective lining elements are arranged on the lining carrier, and the parameters α and β from the wear law

A₁/A₂=(D₁/D₂)^{β′α}.

Here, the material characteristic value parameter α has values between 0.6 and 1.4. Here, values for the material characteristic value parameter β lie between 1.5 and 2.5.

This results in a lower surface pressure in the case of the radially outer lining elements 41 on account of their larger friction face, in the case of a brake application force F_{Z} which is distributed uniformly to the lining elements 41, 42 of a carrier plate 5.

Here, the uniform distribution of the brake application force F_{Z} to the individual lining elements 41, 42 takes place by way of a suitable selection of the arrangement of the lining elements 41, 42 on the carrier plate 5.

Thus, as shown in FIG. 4, in each case two lining elements 41, 42 of identical area of a group element 4 are arranged on the lining carrier 5 on a radius of the rotational axis of the brake disk 6, whereas a third lining element 42, 41 is arranged radially further to the inside or to the outside.

If the group element 4 which is shown in FIG. 3 is considered, the two lining elements 41 of identical area are spaced apart radially from the bearing point of the group element 4 at a spacing h₁, whereas the further lining element 42 is spaced apart radially from the bearing point of the group element 4 at a spacing h₂. Moreover, the two lining elements 41 are arranged symmetrically with respect to an axis of symmetry which is laid through the bearing point of the group element 4 and the cam 55. As a result, the forces which act on the two lining elements 41 are identical.

Accordingly, the following applies to the force which acts on the further lining element 42:

$${F}_{42} = 2 \cdot {F}_{41} \cdot \frac{{h}_{1}}{{h}_{2}} .$$

where h₂=2·h₁, it follows that

$${F}_{42} = 2 \cdot {F}_{41} \cdot \frac{{h}_{1}}{2 \cdot {h}_{2}} = {F}_{41} .$$

In the case of the design variant which is shown in FIG. 5, the individual lining elements 43 have friction faces of identical size. In the case of the design variant, the carrier plates 5 are shaped in such a way that the brake force which is transmitted from the carrier plates 5 to the bearing elements which are coupled to them is lower for lining elements 43 of a carrier plate 5 which are arranged radially further to the outside than for lining elements 43 of the carrier plate 5 which are arranged radially further to the inside.

This is optionally achieved by virtue of the fact that the length ratio h₂ᵢ/h₁ᵢ of a carrier plate 5 for a group element 4 with two lining elements 43 which lie radially on the inside is greater than 2, and the length ratio h₂ₐ/h₁ₐ of the associated carrier plate 5 is lower than 2 for a group element 4 with two lining elements 43 which lie radially on the outside.

In the case of the design variant which is shown in FIG. 5, moreover, it can be seen that the geometry of the group elements 4 which are closer radially to the rotational axis of the brake disk 6 have a somewhat different geometry than the group elements 4 of the group elements which are further away radially from the rotational axis of the brake disk 6. Here, the geometrical design of the group elements is selected in such a way that the lining elements of a group element which are close to the rotational axis of the brake disk are loaded with a higher force than the lining elements which are further away radially from the rotational axis of the brake disk 6.

The configuration variant also results in a surface pressure P which is adapted for the lining elements 43 which are arranged on a predefined orbital path diameter D₁, D₂.

The method according to disclosed embodiments for actuating a brake lining 1 for a partially lined disk brake of a rail vehicle, which brake lining 1 is secured on a lining holder 2 of a brake disk arrangement of a rail vehicle, having a plurality of lining elements 41, 42, 43 which are mounted spherically on a lining carrier 3 via carrier plates 5, is distinguished by the fact that, when the brake lining 1 is loaded with a brake application force, the brake application force is distributed to the lining elements 41, 42, 43 in such a way that the surface pressure which acts on the lining elements 41, 42, 43 decreases as the radial spacing increases from the rotational axis of the brake disk 6.

As a result of the surface pressure via all the above-described functional groups (lining elements, group elements, entire lining), which surface pressure is reduced continuously as the spacing increases from the rotational axis of the brake disk 6, a tendency for oblique wear of the lining elements is reduced substantially.

As a result, a more uniform contact pattern of the brake lining over the entire wear height is achieved. A more uniform introduction of heat into the brake disk surface is made possible even in the case of advanced lining wear, as a result of which the thermal loading of the brake disk is reduced.

The wear of the brake lining in relation to the braking energy is also reduced on account of a more uniform and therefore lower surface temperature on the brake disk.

On its side which faces away from the lining carrier 3, the lining holder 2 has a spring clip 22 and a pin which can be braced by way of the former and engages through a plate 21 of the lining holder 2 into a recess which is provided to this end in the lining carrier 3.

### LIST OF DESIGNATIONS

1 Brake lining
2 Lining holder
21 Plate
22 Spring clip
3 Lining carrier
31 Cutout
32 Spherical recess
33 Recess
4 Group element
41 Lining element
411 Friction lining
412 Element carrier plate
413 Bearing element
414 Spherical face
415 Spring element
42 Lining element
423 Bearing element
43 Lining element
5 Carrier plate
51 Finger
52 Finger
53 Finger
54 Cutout
55 Cam
56 Bearing elements
57 Cam
6 Brake disk
h₁ Radial spacing
h₂ Radial spacing
h₁ᵢ Radial spacing
h₂ᵢ Radial spacing
h₁ₐ Radial spacing
h₂ₐ Radial spacing
a Distance
F_{Z} Brake application force
F_{P} Pressing force
P Surface pressure
S Centroid

1. A brake lining for a partially lined disk brake of a rail vehicle, the brake lining comprising:
a lining carrier;
a plurality of lining elements which are mounted on the lining carrier via a plurality of carrier plates;
wherein the plurality of carrier plates are mounted spherically on the lining carrier, the lining elements are mounted spherically on the plurality of carrier plates, and
wherein the mounting of the lining elements via the plurality of carrier plates on the lining carrier is designed such that a surface pressure of the lining elements which is produced by way of a brake application force during pressing of the lining elements onto a brake disk decreases radially with respect to the rotational axis of the brake disk at an increasing spacing of the lining elements from the rotational axis of the brake disk.

2. The brake lining of claim 1, wherein spherically curved faces of the lining elements which transmit the brake application force to the lining elements during a braking operation are arranged on the lining elements such that the spherically curved faces are offset with respect to the centroid of the lining elements radially toward the rotational axis of the brake disk.

3. The brake lining of claim 1, further comprising a plurality of group elements formed from each carrier plate of the plurality of carrier plates and the plurality of lining elements which are mounted on it are arranged on the lining carrier (3).

4. The brake lining of claim 3, wherein each of the group elements has three lining elements of the plurality of lining elements.

5. The brake lining of claim 3, wherein each of the plurality of carrier plates have bearing elements for spherical mounting on the lining carrier, and cutouts which are spaced apart from the respective bearing element and in which bearing elements of the lining elements are received.

6. The brake lining of claim 1, wherein each of the plurality of carrier plates are shaped such that the brake force is transmitted from the plurality of carrier plates to the spherically curved faces which are coupled to them is identical for each of the lining elements (41, 42) corresponding to a carrier plate a plurality of carrier plates, the friction face of the lining elements of first lining elements which are arranged radially further to the outside being larger than the friction face of the lining elements of second lining elements which are arranged radially further to the inside.

7. The brake lining of claim 1, wherein the plurality of carrier plates are shaped such that the brake force which is transmitted from the plurality of carrier plates to the spherically curved faces which are coupled to them is lower for lining elements of a carrier plate of the plurality of carrier plates which are arranged radially further to the outside than for lining elements of a carrier plate of the plurality of carrier plates which are arranged radially further to the inside, wherein the friction face of all lining elements are of identical size.

8. The brake lining of claim 7, wherein a carrier plate of the plurality of carrier plates for a group element with a lining element which lies radially on the outside, the length ratio (h₂ᵢ/h₁ᵢ) of the radial spacings (h₂ᵢ, h₁ᵢ) between the bearing point of a lining element which is arranged radially further to the outside and the bearing point of the group element and between the bearing point of a lining element which is arranged radially further to the inside and the bearing point of the group element is greater than 2.

9. The brake lining of claim 7, wherein a carrier plate of the plurality of carrier plates for a group element with a lining element which lies radially on the inside, the length ratio (h₂ₐ/h₁ₐ) of the radial spacings (h₂ₐ, h₁ₐ) between the bearing point of a lining element which is arranged radially further to the inside and the bearing point of the group element and between the bearing point of a lining element which is arranged radially further to the outside and the bearing point of the group element is lower than 2.

10. The brake lining of claim 1, wherein the plurality of carrier plates have fingers which extend away from the bearing element and in which the cutouts for receiving the bearing elements of the lining elements are provided.

11. The brake lining of claim 1, wherein two of the lining elements of a group element are oriented approximately on a circle line which is concentric with respect to the rotational axis of the brake disk.

12. An arrangement of a brake lining for a partially lined disk brake of a rail vehicle on a lining holder of a brake disk arrangement of a rail vehicle, wherein the brake lining includes:
a lining carrier;
a plurality of lining elements which are mounted on the lining carrier via a plurality of carrier plates,
wherein the plurality of carrier plates are mounted spherically on the lining carrier, the lining elements are mounted spherically on the plurality of carrier plates, and
wherein the mounting of the lining elements via the plurality of carrier plates on the lining carrier is designed such that a surface pressure of the lining elements which is produced by way of a brake application force during pressing of the lining elements onto a brake disk decreases radially with respect to the rotational axis of the brake disk at an increasing spacing of the lining elements from the rotational axis of the brake disk.

13. A method for actuating a brake lining for a partially lined disk brake of a rail vehicle, which brake lining is secured on a lining holder of a brake disk arrangement of a rail vehicle, having a plurality of lining elements mounted spherically via carrier plates on a lining carrier, the method comprising:
when the brake lining is loaded with a brake application force, distributing the brake application force to the lining elements such that surface pressure which acts on the lining elements decreases at an increasing radial spacing from a rotational axis of the brake disk.
